(19) United States
(12) Patent Application Publication
(10) Pub. No.: US 2017/0118950 A1
(43) Pub. Date: May 4, 2017

(54) CAP-SHAPED PET HOUSE

(71) Applicant: Jingmin Xu, Taichung City (TW)

(72) Inventor: Jingmin Xu, Taichung City (TW)

(21) Appl. No.: 15/340,887

(22) Filed: Nov. 1, 2016

(30) Foreign Application Priority Data
Nov. 2, 2015 (CN) 201520862638.6

(51) Int. Cl. A01K 1/035; A01K 1/03; E04H 15/02; E04H 15/18; E04H 15/58; E04H 15/64; E04H 15/44; E04H 15/32; A01K 1/015; E04H 15/56

(52) U.S. Cl. CPC A01K 1/0353; A01K 1/0157; A01K 1/033; E04H 15/02; E04H 15/56; E04H 15/58; E04H 15/64; E04H 15/44; E04H 15/324; E04H 15/18

(57) ABSTRACT

A pet housing/carrier including a base having a floor with a rim mounted thereon and projecting around the periphery thereof, a collapsible canopy defining a crown for mounting on the rim and detachably attached thereto, the crown constructed of multiple triangular panels rising upwardly from the rim and turning radially inwardly, and being constructed to be self-supporting.

### CROSS-REFERENCES TO RELATED APPLICATIONS

This application claims priority from China Patent Application No. 201520862638.6, filed Nov. 2, 2015, incorporated by reference in its entirety.

### BACKGROUND

The present invention relates to small houses for housing small or mid-size pets.

### DESCRIPTION OF THE PRIOR ART

Numerous different styles of pet carriers and houses have been proposed, including rigid helmet shaped housings. Many such devices provide an integral housing which renders the interior difficult to access for the purpose of cleaning and sanitizing. Some such devices are of rigid construction, making shipment and storage somewhat of a challenge.

Numerous different pet houses and carriers have been proposed of a shape to simulate sports caps and headgear. Examples are in U.S. Patent Nos. D706,491 to Bratton, D616,159 and D608057 to Zagar. Bratton has also proposed a sports cap shaped pet house/carrier as shown in U.S. Pat. No. D706,492. While such devices may prove useful for camouflaging a pet house they do not provide a convenient and practical collapsible house or carrier which would be convenient to fold into a compact package for shipping and storage or transport to a vacation home or the like and which would provide for quick and convenient erection for use at a new location.

Many pet owners prefer to keep their pets in their own living quarters in close contact for companionship and monitoring. It is desirable to have a pet housing where the pet might retreat to a comfortable and familiar zone for rest and sleeping quarters. It is desirable to have the pet housing of a style and configuration which is attractive for the family members and house guests alike.

Many pet owners have affiliations and loyalty with various athletic teams in sports such as baseball, soccer, football and basketball. These teams often have mascots, logos and colors which are incorporated into novelties such as caps and the like, identifying the colors, logo and style of the team of interest. There thus exists a need for a pet house structure which is convenient and attractive for displaying in the resident's living quarters, and which might exhibit a configuration and décor identifiable with the owner's favorite athletic team. It is this need to which the present invention is directed.

### SUMMARY OF THE INVENTION

A housing device including a base formed with a rounded floor and a forwardly projecting planar visor. A rim of a predetermined configuration is mounted on the floor and is formed with a perimeter having an outwardly facing surface. A pad is received within the rim and first attachment element mounted on the exterior of the rim. A collapsible, spherically-shaped crown wall is constructed to define a living space and terminates in a lower extremity to fit over the rim and is formed with an inwardly facing second attachment element to releasably attach to the first attachment element. The wall is constructed of triangular-shaped panels having opposite edges tapering upwardly and inwardly and abutted together along their adjacent edges for being connected together along such edges to form flexible joints with one or more of the panels being cut away in the lower portion to form a doorway for ingress and egress.

The features and advantages of the invention will be more readily understood from the following detailed description which should be read in conjunction with the accompanying drawings.

### BRIEF DESCRIPTION OF THE DRAWINGS

FIG. 1 is a top plan view of a pet housing apparatus embodying the present invention;

FIG. 2A is an elevational view, in enlarged scale, showing a crown wall incorporated in the invention shown in FIG. 1, disassembled and being folded on itself;

FIG. 2B is a view similar to FIG. 2A but with the crown wall in the fully folded position.

FIG. 3 is an exploded perspective view, in a reduced scale, of the housing apparatus shown in FIG. 1;

FIG. 4 is a perspective view in enlarged scale of a compression fitting incorporated in the housing apparatus shown in FIG. 1;

FIG. 5 is a left side view of the pet house apparatus shown in FIG. 1;

FIG. 6 is a back view in enlarged scale of the pet house shown in FIG. 1; and

FIG. 7 is a perspective view of a cushioning pad included in the house apparatus shown in FIG. 1.

### DETAILED DESCRIPTION OF THE PREFERRED EMBODIMENTS

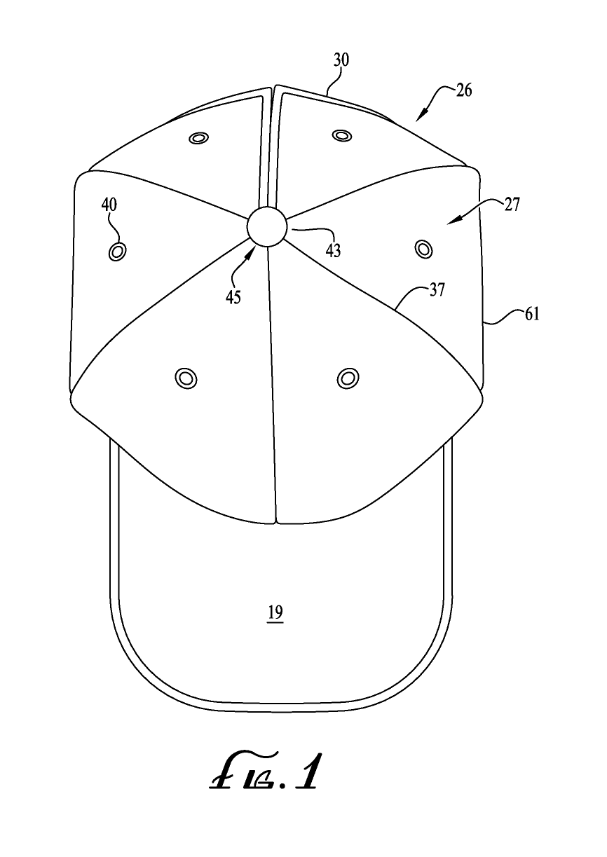

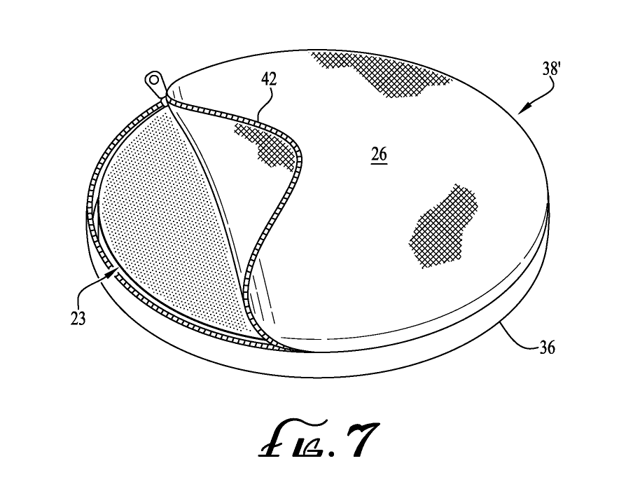

Referring FIGS. 1 and 3, the pet housing apparatus of the present invention includes, generally, a base 15, formed with a circular floor 17 and forwardly projecting planar visor 19. A circular band defines a rim, generally designated 21, surrounding the floor 17. A pad device 39 is received within the rim 21 to rest on the floor 17. A crown housing 26 is formed by a plurality of triangular shaped panels 27 to cooperate in forming a living space over the pad device 23. In a preferred embodiment, the panels 27 are constructed of a coarse, self, supporting cloth material and connected along their edges to form flexible joints and cooperating to closely simulate the appearance of a conventional design of an oversized baseball cap. A pair of panels at the rear are cut away in the lower portion to form a pet doorway 20 (FIG. 6).

In one preferred embodiment, the triangular panels 27 are constructed of coarse cloth material to cooperate in simulating the configuration of an oversized baseball cap. Baseball caps, sometimes called snap-back caps, are often worn as a fashion item and frequently are adorned with the trade dress and logos of one's favorite sports team. Such caps typically incorporate a bill or visor at the front to shade the wearer's eyes.

It is known that cloth is typically either woven or knitted and can be made of a large variety of fibers, which in turn can be natural, cellulose or synthetic. The main difference between types of cloth include how the cloth is made, i.e., woven, knitted, felted, how these techniques were implemented, what fiber it was made from, and what weight the cloth is. Different types of cloth used for different types of clothing include fabric made of cotton, flax, wool, ramie, silk, denim, leather, down (for down-filled parkas) and fur. Some clothing is made of synthetic fibers, which are primarily from petrochemicals. Common man-made materials include nylon, polymers, including naturally occurring chemicals and synthetics, and Spandex (elastane). For the purposes of this application, it will be recognized by those skilled in the art that the cloth material for the triangular panels may include any of the foregoing cloth materials or others that will occur to those of ordinary skill in the art, it only being important that it have sufficient body in this construction to, in the deployed configuration, remain erect over the floor to cooperate in forming a pet living space.

Referring to FIGS. 1 and 3, it will be appreciated that the floor 17 may be constructed of rigid or slightly flexible pad material and the rim 15 constructed of, for instance, a combination of hard plastic band having an outwardly facing pile material 31 around the major circumference thereof, and possibly a smooth plastic section 33 at the back thereof to define the lower perimeter of the doorway 20. Referring to FIG. 6, the lower extremities of the panels 27 defining the doorway are releasably fastened to the rim by respective snap fasteners 30 and may be released to from opposite door flaps. The edges of the two panels and the panels themselves may be trimmed by binding for an attractive finish.

In a preferred embodiment, the visor 19 is planar and of semi-rigid construction to lay flat on the underlying support surface projecting forwardly to define a lever arm to stabilize the apparatus from tipping forward with the base.

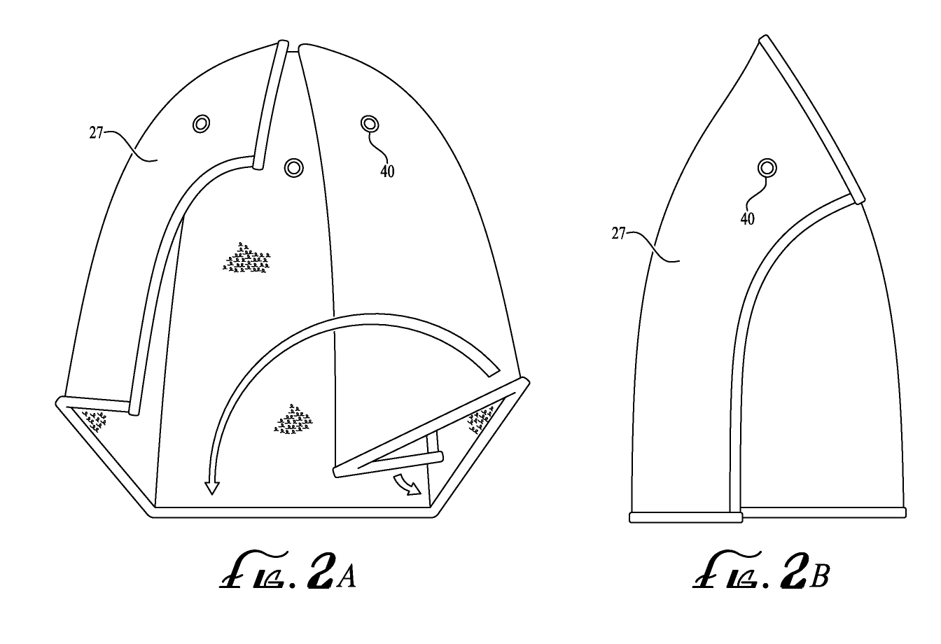

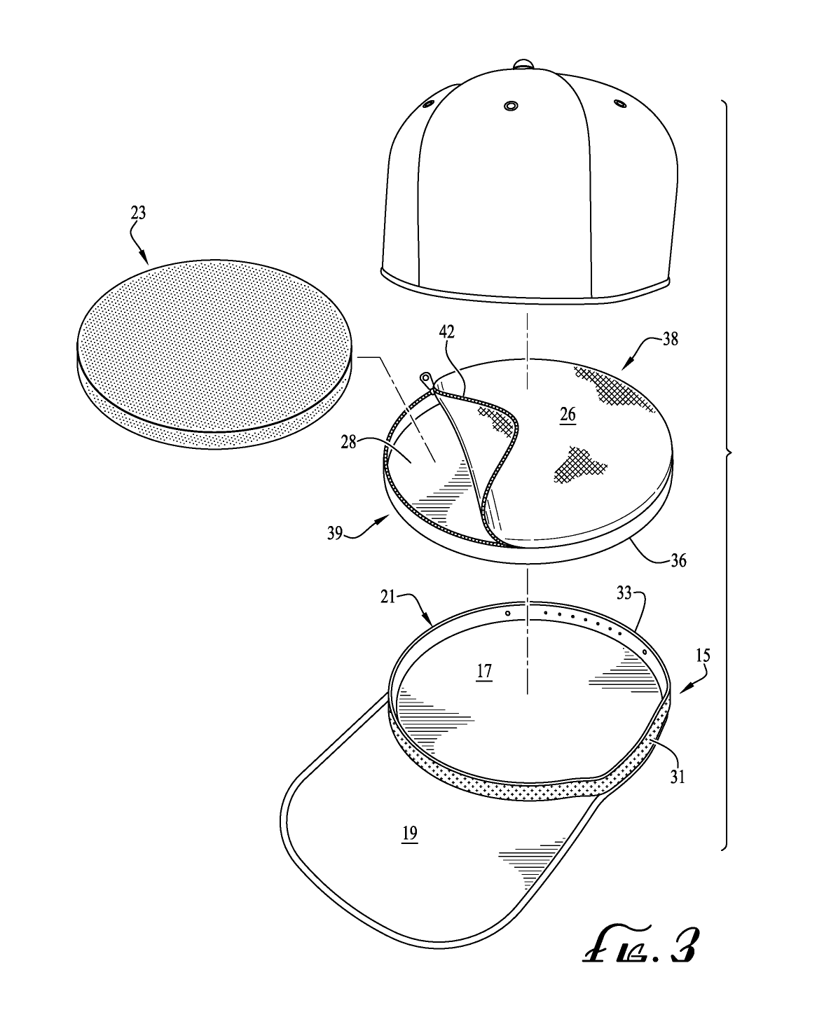

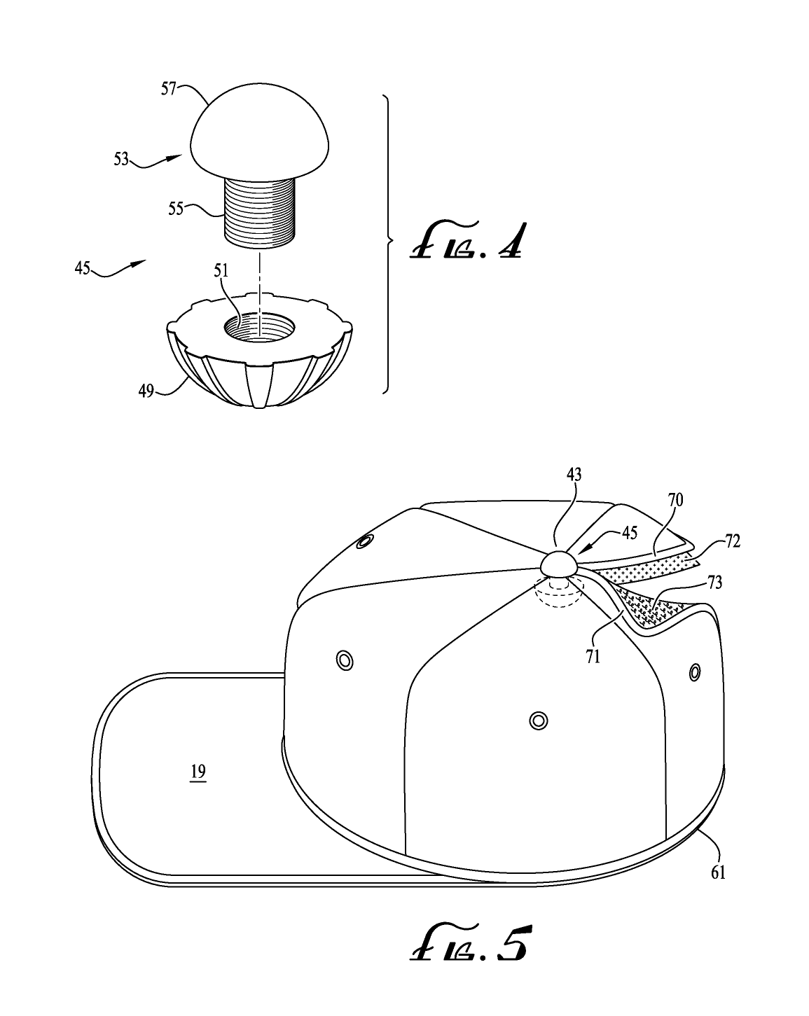

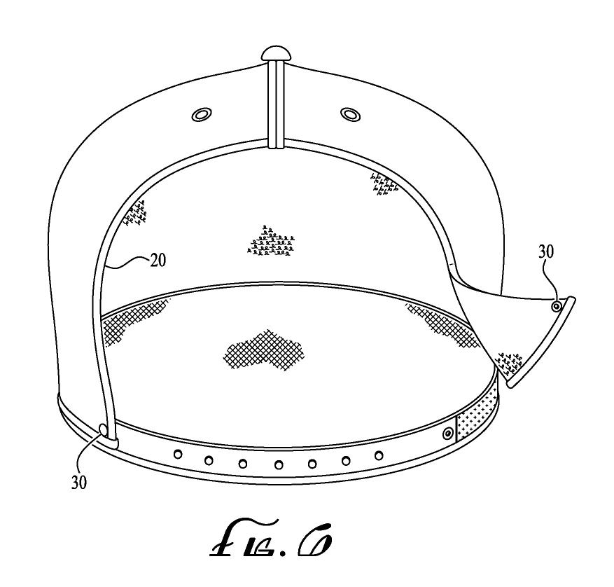

The panels 27 may be constructed of a coarse cloth or woven fiber, preferably having sufficient body to be self-supporting in the overall construction. The edges of the panels may be turned inwardly toward the living space and the abutted edges sewn along the respective seams 37 with stitching to form flexible joints so that for the contracted position they may be folded to the flattened configuration shown in FIG. 2B.

Referring to FIG. 7, the pad device 39 in some embodiments is formed with a circular foam disk 23 having a thickness of quarter to one-half inch. A flat cylindrical envelope 38 may envelope the disk 23. The top wall 26 of the envelope may be permeable and the bottom well 28 impermeable. The envelope may be formed with an opening to be closed by a zipper fastener 42.

The panels 27 rise upwardly and curve inwardly to cooperate in forming an overall spherical shape simulating the crown of, for instance, a baseball cap, and terminate in respective top apexes 43 joining together at a joint. At the joint, the apexes are cut away to form a through vertical bore. A compression fitting, generally designated 45, is received within the bore. The compression fitting 45 includes a female nut 49 on the interior of the crown. The nut 49 is formed with an internally threaded, upwardly opening bore 51. A male connector, generally designated 53, is formed with a downwardly projecting, externally threaded shaft 55 received in the bore 51. The male connector 53 is formed with a circular head 57 for cooperating as the shaft 55 is threaded into the bore 51 to compress the material at the respective panel apexes to cooperate in maintaining the overall structure. In practice, the head 57 is covered with a colored fabric matching the color of the panels 27, as for instance a royal blue color, to simulate the conventional button on top of a baseball cap.

To facilitate collapse of the housing, the panels forming the opposite sides of the doorway 20 are left unconnected along the abutting edges above the doorway to leave free edges 70 and 71. Hook and pile fastening tapes 72 and 73 are sewn to such edges for selectively fastening such edges together when the crown in fully erected.

The interior of the panels 27 are lined with a felt liner, which extends down to the lower extremities 61 forming the bottom perimeter of the housing to releasably connect with the pile material 31 on the exterior surface of the rim 21.

Thus, in operation, the base 15, with or without the pad device 23, may be packaged and shipped to the customer with such crown housing 26 in the collapsed folded position shown in FIG. 2B.

The user may then conveniently assemble the housing apparatus by placing the pad device within the rim 21. The crown housing 26 may then be unfolded by deploying the panels 27 to form the dome shape depicted in FIG. 1. The lower extremity of such crown housing may then be fitted over the exterior surface of the rim 21 with the felt liner adhered to the pile material 31 and fasteners 30 snappped to releasably attach it in place, closing the forward portion of the housing apparatus and leaving the rearwardly facing doorway 20 open for ingress and egress of the pet. To shore up the self-supporting of the crown housing, the fasters 72 and 73 (FIG. 3) may be closed on one another and the compression fitting 45. The pet can rest comfortably on the pad device and should it bump the wall of the housing 26 the visor 9 will provide support against tipping over. The pet may then enter the living space defined by the crown hosing 26 and to lie on the pad device 23 in a comfortable position.

For access to the interior, the pet owner may conveniently unfasten the fastener strips 72 and 73 and unsnap the ring fasteners 30 to access the interior for cleaning and the like or for collapse of the crown.

As will be appreciated by those skilled in the art, the house/carrier of the present invention is particularly convenient for use with mid-size and larger animals where the house would have considerable bulk and size, rendering shipping and storage relatively expensive and inconvenient. With the device of the present invention, the crown of the house may be easily detached from the base and folded into a compact package per FIGS. 2A and 2B for convenient shipping and storage. The device can be readily erected at a new location without any significant consumption of time or requirement of mechanical skills.

The invention may be embodied in other forms without departure from the spirit and essential characteristics thereof. The embodiments described therefore are to be considered in all respects as illustrative and not restrictive. Although the present invention has been described in terms of certain preferred embodiments, other embodiments that are apparent to those of ordinary skill in the art are also within the scope of the invention. Accordingly, the scope of the invention is intended to be defined only by reference to the appended claims.

I claim:

1. A cap shaped pet house apparatus for housing a pet and comprising:
a base including a floor of a preconfigured configuration and a forwardly projecting planar visor;
a rim of the predetermined configuration on the floor and having an outwardly facing surface;
a pad received in the rim;
a first attachment element on the outwardly facing surface;
a spherically shaped crown wall defining a housing cooperating with the floor to form an internal living space and terminating in a lower extremity configured to fit over the rim and formed with an inwardly facing second attachment element to releasable attach to the first attachment;
the housing constructed of flexible triangular shaped panels having opposite edges tapering upwardly and inwardly and abutted together along their adjacent edges;
stitching fastens the adjacent edges of the respective panels together for form flexible joints, the panels and joints being configured to provide for the panels to be folded on one another to collapse the housing to a folded configuration and to be unfolded to deploy to a deployed configuration cooperate with the floor to form the interior living space; and
one or more of the panels configured with an pet-access doorway for ingress and egress of the pet;

2. The cap-shaped pet house apparatus as set forth in claim 1 wherein:
the panels are constructed of cloth.

3. The cap-shaped pet house apparatus as set forth in claim 1 wherein:
the first attachment element includes pile and the second the attachment element includes felt.

4. The cap-shaped pet house apparatus as set forth in claim 1 wherein:
a pair of the panels are juxtaposed and cut away to cooperate in forming the doorway and include upper portions having confronting edges; and
a releasable fastener fasting the confronting edges together.

5. The cap-shaped pet house apparatus as set forth in claim 1 that includes:
a pair of snap fasteners on opposite sides of the opening for fastening the lower extremity to the rim.

6. The cap-shaped pet house apparatus as set forth in claim 1 wherein:
the panels are formed with upper apexes formed together and cooperating to form a through-bore; and
the apparatus includes a fastener projecting through the bore and configured with the heads to up on the fastener being fastened compress the apexes.

7. The cap-shaped pet house apparatus as set forth in claim 1 wherein:
the rim is circular.

8. The cap-shaped pet house apparatus as set forth in claim 1 wherein:
the visor is semi-rigid.

9. A pet house apparatus comprising:
a base formed with a circular floor and forwardly projecting planar visor defining a stabilizer;
a circular rim circumscribing the floor;
a pile material on the outside of the rim and extending a predetermined distance about the rim;
a circular pad device configured to be complementarily received within the rim, the pad device including a circular absorptive pad and envelope device enveloping the pad and formed with an envelope opening;
a zipper for selectively closing the envelope opening;
the envelope device including a porous top to sheet and a non-porous bottom sheet;
a spherical crown housing received on the rim and formed with a lower extremity having an inwardly facing felt material for releasably attaching to the pile material;
the crown including six fan-shaped panels, each having opposite edges angling upwardly and inwardly toward one another and curved radially inwardly over the floor, the fan shaped panels terminating in respective juxtaposed apexes cooperating to define a through-bore of a predetermined diameter;
a pair of the triangular panels being adjacent one another and cut away in the lower portion to form a rearwardly facing doorway for ingress and egress of a pet;
the pair of adjacent panels formed over the doorway with respective adjacent edge sections for abutting one another;
a pile and hook fastener device carried from the respective adjacent edge sections for releasably attaching to one another to facilitate opening of the crown above the doorway;
a compression fitting including a screw fastener having a head of a diameter larger the selected diameter and including an externally threaded shaft projecting through the bore, and a nut device for threadable connection to the lower end of the shaft.

10. The cap-shaped pet house apparatus as set forth in claim 1 wherein:
the pair of panels are configured to define the doorway to a rounded top.

11. The pet house apparatus as set forth in claim 9 wherein:
the pair of panels are formed with lower portions defining flaps to be releasably attached at their respective lower extremities to the rim.
